(19) United States
(12) Patent Application Publication
(10) Pub. No.: US 2014/0080402 A1
(43) Pub. Date: Mar. 20, 2014

(54) Adjustable Air Flow Restrictors

(71) Applicant: James A. Staelgraeve, II, Oswego, IL (US)

(72) Inventor: James A. Staelgraeve, II, Oswego, IL (US)

(21) Appl. No.: 13/622,449

(22) Filed: Sep. 19, 2012

(51) Int. Cl. F24F 11/04; F15D 1/02

(52) U.S. Cl. 454/239; 138/45

(57) ABSTRACT

Apparatuses and methods are described for adjusting air flow in a forced-air delivery system.

### BACKGROUND

Unless otherwise indicated herein, the materials described in this section are not prior art to the claims in this application and are not admitted to be prior art by inclusion in this section.

Forced-air delivery systems are commonly used to regulate the temperature and air flow in both residential and commercial structures. These systems may include a fan or blower to move the air, a heating and/or cooling element, and a series of interconnected ducts to carry air throughout the structure. Often, different rooms within a structure may experience different air flow results in a forced-air delivery system due to a number of factors. These factors include, among other things, the location of the room in relation to the fan, the size and geometry of the ducts leading both to and from the room, and the number and size of rooms. For this reason, many forced-air delivery systems also include dampers or other structures placed within the ducts to restrict air flow and regulate air pressure in the system. Multiple dampers can thereby regulate the air flow throughout the structure.

Nonetheless, many residential and commercial structures experience uneven heating and cooling and/or unbalanced air conditions due to the ineffective design of the air restrictors. Consequently, an improved air flow restrictor is needed that is efficient, adjustable, and easily installed.

### SUMMARY

The disclosure herein generally relates to apparatuses and methods for adjusting air flow in a forced-air delivery system. In one example embodiment, an apparatus is provided. The apparatus may include a plate capable of placement within an air duct, the plate including a perimeter, an orifice, and a plurality of elongate members extending from the plate, where each elongate member of the plurality of elongate members is independently moveable to partially obstruct air flow through the orifice.

In a further aspect, an apparatus is provided. The apparatus may include a plate capable of placement within an air duct, the plate including a perimeter and an orifice eccentrically located within the plate.

In a further aspect, a method is provided. The method may include

(1) positioning a plate with an orifice and a plurality of elongate members within an air duct and (2) moving at least one elongate member of the plurality of elongate members to partially obstruct air flow through orifice.

In a further aspect, a method is provided. The method may include

(1) positioning a plate with an eccentrically located orifice within an air duct and (2) rotating the plate, where the rotation is substantially within a plane defined by the plate.

In a further aspect, a method of balancing the air exchange in a room is provided. The method may include (1) measuring a supply air flow rate to the room from a supply air duct, (2) measuring a return air flow rate from the room to a return air duct, (3) determining a desired ratio, and (4) positioning a plate within the return air duct, the plate comprising an orifice, and where a ratio of the supply air flow rate to the return air flow rate is the desired ratio.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1A shows an example apparatus for adjusting air flow in a forced-air delivery system according to an example embodiment.

FIG. 1B shows another view of the example apparatus of FIG. 1A where two of the elongate members have been moved.

FIG. 1C shows an example apparatus for adjusting air flow in a forced-air delivery system according to an example embodiment.

FIG. 2A shows an example apparatus for adjusting air flow in a forced-air delivery system according to an example embodiment.

FIG. 2B shows the example apparatus of FIG. 2A placed within an air duct at a first rotational position.

FIG. 2C shows the example apparatus of FIG. 2A placed within an air duct at a second rotational position.

FIG. 3 shows an example apparatus for adjusting air flow in a forced-air delivery system according to an example embodiment.

FIG. 4 shows a flowchart depicting an example method of balancing the air exchange in a room.

### DETAILED DESCRIPTION

Air Flow Restrictors

Apparatuses and methods are described for adjusting air flow in a forced-air delivery system. In an example embodiment, an air flow restrictor may include a plate with a perimeter and an orifice. Extending from the plate may be a plurality of elongate members which are each independently moveable to partially obstruct air flow through the orifice. The elongate members may extend from anywhere on the plate, including the perimeter of the plate, the perimeter of the orifice, or any other location.

The plate may be of any shape or size in order to fit within the desired duct, such as circular or rectangular. Similarly, the orifice may be of any shape or size depending on the desired level of restriction, the arrangement of the elongate members, or any other factor. In some embodiments, the size of the orifice may be large enough that it takes up substantially all of the plate, leaving only enough material to support the plate and the elongate members.

Additionally, because each of the elongate members is independently moveable to obstruct the orifice, the amount of air restriction is adjustable once the apparatus is positioned within a duct. If one of the elongate members does not provide enough obstruction to restrict the air flow to the desired level, one or more additional members may be moved to partially obstruct the flow until the desired level of restriction is reached.

In some embodiments, the elongate members may be coexistant with the plate. For instance, the plate and elongate members may be integrally formed from a single piece of sheet metal. In order for the elongate members to move and obstruct air flow in such an embodiment, the members may be, for example, bendable. In other embodiments, the elongate members may be formed separately from the plate, and then attached to the plate. For example, the elongate members may be hingeably connected to the plate such that the members can be moved to partially obstruct the orifice.

In another example embodiment, an air flow restrictor may include a plate with an orifice that is eccentrically located within the plate. The eccentric orifice provides for the adjustment of the amount of air restriction in a duct when the velocity profile of the air moving within a duct is not uniform. For example, air moving around a 90 degree bend in a duct will exhibit a greater velocity at the outside of the bend, and a lesser velocity at the inside of the bend. This type of non-uniform air flow is particularly common in a forced-air system where the ducts change sizes and make frequent bends, which is often the case in most residential and commercial structures.

Accordingly, once a plate with an eccentric orifice is positioned within a duct, the plate may be rotated, where the rotation is within a plane defined by the plate. This will reposition the orifice to align with a different point in the duct's air velocity profile, and therefore provide a different amount of restriction. For instance, rotating the orifice to align with a region of low velocity will provide a greater restriction of air flow than if the orifice were aligned with a region of high velocity. While this method of air restriction may be most effective when the restrictor is placed shortly after a bend in the duct, this placement may not be possible in some cases. Nevertheless, one skilled in the art would recognize that similar effects may be achieved anywhere that the air velocity profile within the duct is not uniform, a condition which is not limited to locations where the duct bends.

In another example embodiment, an air flow restrictor may include a plate with both an eccentric orifice and a plurality of elongate members which are movable to obstruct air flow through the orifice. In this way, a restrictor may have greater flexibility in adjusting the amount of air restriction through either rotation of the plate, movement of the elongate members, or a combination of both. Additionally, because the eccentric orifice may be located closer to some elongate members than others, each of the members may provide a different level of air restriction when moved to obstruct the orifice. For instance, in an embodiment where the elongate members extend from the perimeter of the plate, the members nearest to the eccentric orifice may be capable of obstructing more of the orifice than those members which are on the opposite side of the plate.

The air flow restrictors described above may be positioned in the boot of an air duct, in the vicinity of the location where the duct meets the room or space that is to be regulated. Accessing the boot portion of the duct may require only the removal of a grille or diffuser from within the room. This avoids the opening of walls or ceilings in order to reach ducts that are not readily accessible. It also avoids the disassembling of the ducts themselves in order the place the restrictor within. However, the air flow restrictors described above may also be positioned anywhere within the ducts of a forced-air delivery system, and they may be installed when the entire system is originally installed. They may also be placed in a system that is already in place, but is in need of improved air flow regulation.

Finally, in any given air duct, the use of a restrictor will reduce the amount of air flowing through that portion of the duct. It will also increase the air pressure within the duct at that location, which may cause a change in the overall distribution of air throughout the entire duct system. For this reason, one skilled in the art would recognize that the term “restrictor” as used herein refers only to the apparatus's local effects, as a restriction of air flow in one duct may often lead to an increase in air flow in another.

Air Flow Balancing

Effective regulation of air exchange in a forced-air delivery system can improve the results of the system. This may be referred to as the system being properly balanced. Conversely, a system wherein the air exchange is not properly regulated, or unbalanced, can lead to undesired results. For example, a home with unbalanced air exchange may lead to cold or drafty rooms in the winter, or hot rooms in the summer. Rooms in an unbalanced system may also feel stale due to the air not circulating properly between supply and return. Finally, one room may be affected differently than another by changes in the settings of the system, such as temperature or fan speed. These differences may be due to unequal proximity of each room to the fan or dissimilar geometry of the ducts leading to the rooms.

Thus, it may be desirable to balance the air exchange in each room or space within a structure. This may be accomplished by first measuring the supply air flow rate entering the room from one or more supply air ducts and measuring the return air flow rate leaving the room through one or more return air ducts. The measurements may be taken from within the room, at the point where the ducts enter and leave the room. The measurements may be taken with an air flow meter, or any other device adapted to measure air flows.

A desired ratio between the supply and return air flows to the room may be determined. Although the desired result is referred to as a balanced air exchange, this does not mean that the ratio between supply and return must be 1 to 1. Rather, a balanced air exchange is one that provides the desired level of air circulation and comfort within the room. In many cases, a desirable result may be achieved when the supply air flow rate to a room is equal to or greater than the return flow rate. This may result in a room with relatively high air pressure and air circulation, dominated by the supply air flow rate. Where the supply air is conditioned by either heating or cooling, this may result in the desired room temperature.

On the other hand, if the return air flow rate is greater than the supply, it may result in a room with relatively low air pressure and low air circulation. Under these conditions, the supply air may be drawn directly to the return, without the opportunity to circulate properly within the room. This may lead to the undesirable result of a room in which the temperature is not properly regulated by the supply air, and which feels stale upon entering.

Many variables may affect the determination of the desired ratio of supply to return. For example, in some forced-air delivery systems, the return air is fully enclosed within typical ducts back to the fan. This may be referred to as a closed system. In a closed system, where few air flow losses may be expected in the ducts, the desired ratio may be 1 to 1. On the other hand, many forced-air delivery systems do not use fully enclosed ducts for the return air. Rather, the system may utilize the spaces between existing wall joists and/or between ceilings and floors as ducts to channelize the return air flow back to the fan. This may be referred to as an open system. In an open system, the fan is able to draw return air from the entire building envelope, and not just the rooms. In an open system, a desirable ratio between supply and return may be as much as 2 to 1.

For many of the reasons described above, it may be desirable to restrict the return air flow leaving a room to achieve the desired ratio. This may be accomplished by positioning a plate with an orifice within the return air duct. This may be accomplished in a typical air duct, as in a closed system. It may also be accomplished where the space between wall joists is used as the return duct, as in an open system. Additionally, any of the air flow restrictors described above may be used. Further, an air flow restrictor as described above may also be placed within the supply duct to provide greater control and precision in achieving the desired ratio.

Various embodiments of the invention will now be described with reference to the figures. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### Example Embodiments

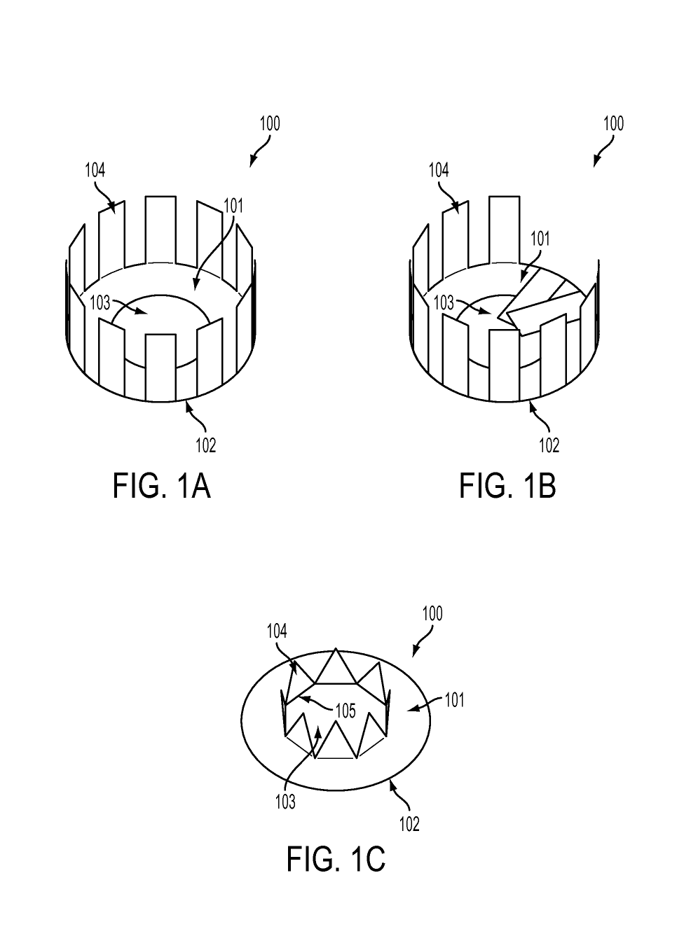

FIG. 1A shows an example apparatus 100 for adjusting air flow in a forced-air delivery system. The apparatus 100 includes a plate 101 that is capable of placement within an air duct. The plate 101 has a perimeter 102, an orifice 103, and a plurality of elongate members 104 extending from the perimeter 102. The apparatus may include any number of elongate members consistent with the structural integrity of the plate and the members. Each of the elongate members 104 is independently moveable to partially obstruct air flow through the orifice 103. FIG. 1B shows an example of the apparatus 100 where two of the elongate members 104 have been moved into a position to obstruct air flow through the orifice 103. Any number of the elongate members 104 may be similarly moved until a desired level of restriction is reached.

FIG. 1C shows another embodiment of the example apparatus 100 where the elongate members 104 extend from the plate 101 at the orifice perimeter 105. The elongate members 104 may extend from any location on the plate 101 such that they are moveable to partially obstruct air flow through the orifice 103. Further, the orifice 103 in FIG. 1C is octagonal in shape to facilitate the movement of the elongate members 104. The orifice 103 may be of any size or shape depending on the desired level of air restriction, the arrangement of the elongate members 104, or any other factor.

Similarly, although the plate 101 in FIGS. 1A, 1B, and 1C is circular, it may be of any shape in order to fit within the desired air duct. A means of fastening the apparatus 100 to the air duct is not shown, but any number of means for keeping the apparatus 100 in place is possible. In some embodiments, the plate 101 may include a series of short tabs, parallel to the elongate members 104, which may be used to fasten the apparatus 100 to the interior of the air duct using screws. Elongate members 104 may be similarly utilized for fastening the apparatus to the air duct. In other embodiments, the apparatus 100 may be held in place by the duct itself, if the fit of the apparatus 100 within the duct is sufficiently snug. Any other method of fixing the apparatus 100 in place is suitable as long as it allows the members to be movable to restrict the air flow through the orifice.

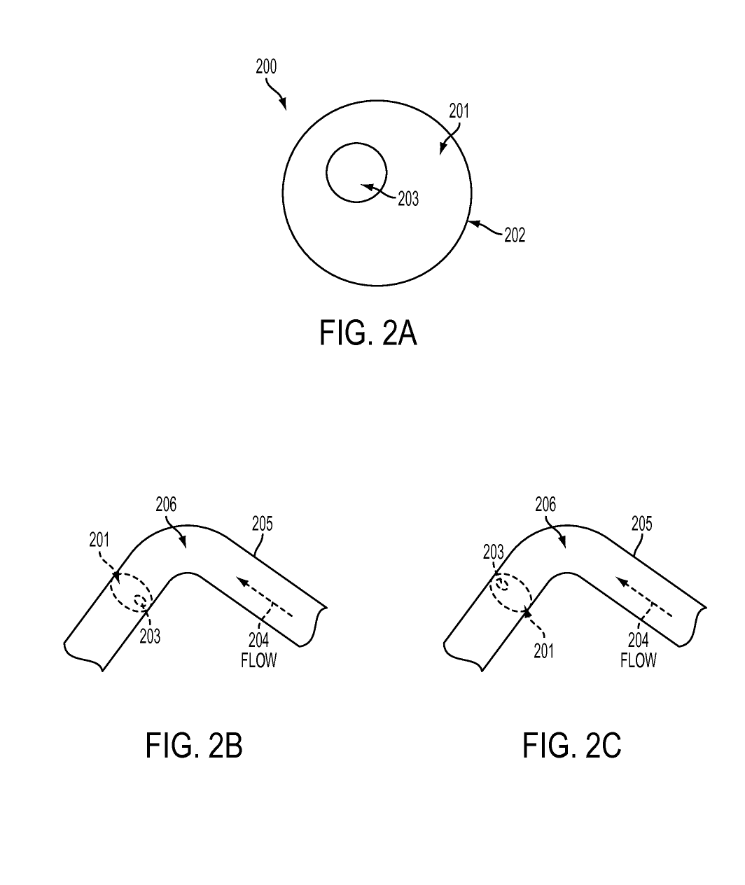

FIG. 2A shows another example apparatus 200 for adjusting air flow in a forced-air delivery system. The apparatus 200 may include a plate 201 that is capable of placement within an air duct. The plate 201 has a perimeter 202 and an orifice 203 that is eccentrically located within the plate 201. As above, numerous means for fastening the apparatus 200 within the air duct are possible.

FIG. 2B shows the apparatus 200 placed within an air duct 205. In the direction of air flow 204, the apparatus 200 is placed shortly after a bend 206 in the air duct 205. The bend 206 may located be in the boot portion of the air duct 205, in the vicinity of the location where the duct meets the room or space that is to be regulated. The bend 206 may also be located at any other point in the air duct system.

In FIG. 2B, the apparatus 200 is rotated such that the eccentric orifice 203 is aligned with the interior side of the bend 206. This may cause the orifice 203 to align with air that is moving at a relatively low velocity within the duct 205. This in turn may create a greater obstruction for the relatively high velocity air which moves along the exterior side of the bend 206. In other words, a higher volume of air faces a greater obstruction. Consequently, a relatively higher level of air flow restriction is achieved compared to an embodiment where orifice is positioned closer to the exterior of the bend.

FIG. 2C is similar to FIG. 2B, showing the apparatus 200 placed at the same location in the duct 205. However, in FIG. 2C the apparatus 200 is rotated such that the eccentric orifice 203 is aligned with the exterior side of the bend 206. This may cause the orifice 203 to align with air that is moving at a relatively high velocity within the duct 205. Thus, there is a lesser obstruction for the higher velocity air moving through this portion of the duct 205. In other words, there is a lesser obstruction for a higher volume of air. Consequently, a relatively lower level of air flow restriction is achieved compared to the embodiment where the orifice is positioned closer to the interior of the bend.

In both FIGS. 2B and 2C, the bend 206 may be the bend that is typically located in the boot connection where a duct meets a room. It may also be any other bend in the duct system. Further, apparatus 200 may be rotated to the desired position before it is fastened to the interior of the air duct. Alternatively, the apparatus 200 may be fastened within the duct, and then unfastened if an adjustment needs to be made. Once the desired rotation is reached, the apparatus 200 may be refastened to the duct.

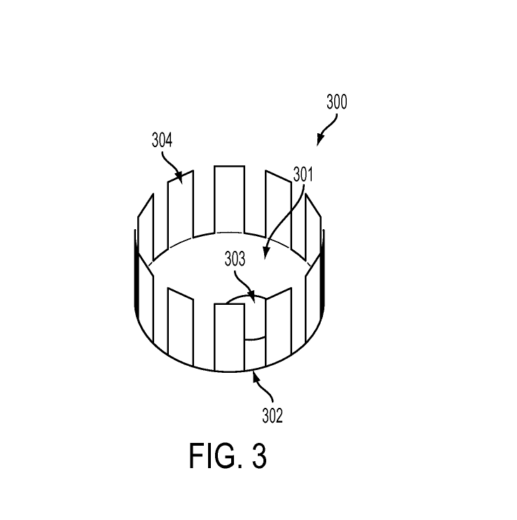

FIG. 3 shows another example apparatus 300 for adjusting air flow in a forced-air delivery system. The apparatus 300 may include a plate 301 that is capable of placement within in air duct. The plate 301 has a perimeter 302 and an orifice 303 that is eccentrically located within the plate 301. The plate 301 also includes a plurality of elongate members 304 extending from the perimeter 302. Each of the elongate members 304 is independently moveable to partially obstruct air flow through the orifice 303. As above, the elongate members 304 may also extend from any other location on the plate 301. The apparatus 300 may be adjusted by either moving the elongate members 304 to partially obstruct the orifice, rotating the apparatus 300 to reposition the orifice 303 within the duct, or a combination of both.

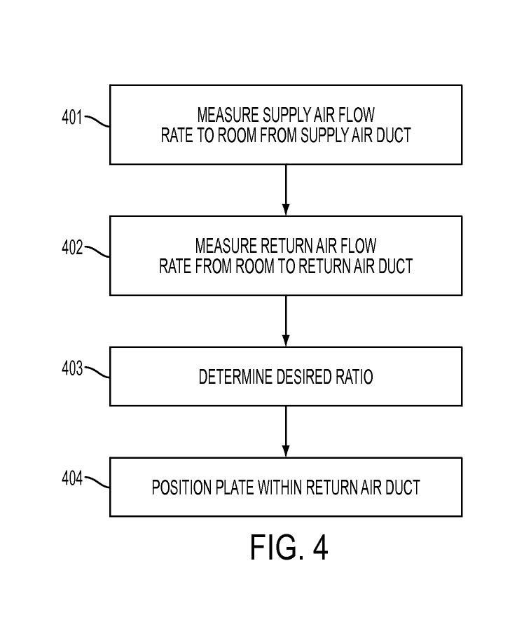

FIG. 4 shows an example method of balancing the air exchange in a room. At block 401, the supply air flow rate into the room from a supply air duct may be measured. At block 402, the return air flow rate from the room to a return air duct may be measured. As described above, the return air duct may be an enclosed duct as found in a closed system. Alternatively, the return air duct may be the existing channels formed by the construction of the structure, as found an open system. At block 403, a desired ratio for the supply air flow to the return air flow is determined. And at block 404, a plate with an orifice is positioned within the return air duct such that the ratio of supply air flow to return air flow is the desired ratio.

One of skill in the art will appreciate that the steps in the method of FIG. 4 need not be completed in any particular order. Further, some of the steps may be performed multiple times before every step is fully completed. For instance, the supply and return air flows may be measured both before and after the plate is positioned within the return air duct. The plate may then be repositioned, and the supply and return air flows measured again. In this way, some of the steps in the method of FIG. 4 may be iterative until the desired ratio of supply to return air flow is achieved. Also, one of skill in the art would appreciate that a single room may have more than one supply and more than one return. The air flow at any or all of the supplies and the returns may be measured and adjusted to achieve the desired ratio.

The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

1. An apparatus for adjusting air flow in a forced-air delivery system comprising:
a plate capable of placement within an air duct, wherein the plate comprises a perimeter, an orifice, and a plurality of elongate members extending from the plate, and wherein each elongate member of the plurality elongate members is independently moveable to partially obstruct air flow through the orifice.

2. The apparatus of claim 1 wherein the orifice is eccentrically located within the plate.

3. The apparatus of claim 1 wherein the elongate members are attached to or coexistant with the perimeter of the plate.

4. The apparatus of claim 1 wherein the orifice comprises a perimeter, and wherein the elongate members are attached to or coexistant with the perimeter of the orifice.

5. The apparatus of claim 1 wherein each member of the plurality of elongate members is independently bendable.

6. The apparatus of claim 1 wherein each member of the plurality of elongate members is hingeably connected to the plate.

7. The apparatus of claim 1 wherein the air duct comprises a boot, and wherein the apparatus is placed within the boot.

8. An apparatus for adjusting air flow in a forced-air delivery system comprising:
a plate capable of placement within an air duct, wherein the plate comprises a perimeter and an orifice eccentrically located within the plate.

9. The apparatus of claim 8 wherein the air duct comprises a boot, and wherein the apparatus is placed within the boot.

10. A method of adjusting air flow in a forced-air delivery system comprising:
positioning the plate of claim 1 within the air duct; and
moving at least one elongate member of the plurality of elongate members to partially obstruct air flow through orifice.

11. The method of claim 10, wherein moving at least one elongate member of the plurality of elongate members comprises bending at least one elongate member of the plurality of elongate members.

12. A method of adjusting air flow in a forced-air delivery system comprising:
positioning the plate of claim 8 within the air duct; and
rotating the plate, wherein the rotation is substantially within a plane defined by the plate.

13. A method of balancing the air exchange in a room comprising:
measuring a supply air flow rate to the room from a supply air duct;
measuring a return air flow rate from the room to a return air duct;
determining a desired ratio; and
positioning a plate within the return air duct, wherein the plate comprises an orifice, and wherein a ratio of the supply air flow rate to the return air flow rate is the desired ratio.

14. The method of claim 13 wherein the plate is the apparatus of claim 1.

15. The method of claim 13 wherein the plate is the apparatus of claim 8.

16. The method of claim 13 further comprising the step of positioning the apparatus of claim 1 within the supply air duct.

17. The method of claim 13 further comprising the step of positioning the apparatus of claim 7 within the supply air duct.

18. The method of claim 13 wherein the desired ratio is 1 to 1.
